(19) United States
(12) Patent Application Publication
(10) Pub. No.: US 2008/0011535 A1
(43) Pub. Date: Jan. 17, 2008

(54) Shift collar for motorcycle transmission

(75) Inventors: Justin Bramstedt, Viroqua, WI (US); Karl Leisenheimer, Bemidji, MN (US)

Correspondence Address: STEPTOE & JOHNSON LLP, 1330 CONNECTICUT AVENUE, N.W., WASHINGTON, DC, 20036, US

(73) Assignee: S & S Cycle, Inc., Viola, WI (US)

(21) Appl. No.: 11/822,949

(22) Filed: Jul. 11, 2007

Related U.S. Application Data
(60) Provisional application No. 60/819,629, filed on Jul. 11, 2006.

(51) Int. Cl. F16H 3/08; B62K 11/00

(52) U.S. Cl. 180/219; 74/325

(57) ABSTRACT

A shift collar for a transmission is disclosed. The shift collar includes a gear engagement surface for engaging a transmission gear, at least seven engagement dogs projecting from the gear engagement surface, a shift sleeve engagement surface for engaging a shift sleeve, and a plurality of grooves formed in the shift sleeve engagement surface for engaging corresponding splines on the shift sleeve. Preferably the engagement dogs are arranged on the gear engagement surface such that each of the engagement dogs engage one of a corresponding number of engagement pockets in the transmission gear.

### RELATED APPLICATIONS

This invention claims the benefit of and priority to U.S. Provisional Patent Application No. 60/819,629, the entire contents of which are incorporated by reference herein in its entirety. This application is related to Published U.S. Patent Application No. 2007/0006673, which is similarly incorporated by reference herein in its entirety.

### FIELD OF THE INVENTION

This invention relates generally to a transmission and more particularly to a motorcycle transmission utilizing a shift collar for engaging and disengaging one or more rotatable parts within the transmission.

### DESCRIPTION OF THE RELATED ART

Transmissions are known to include components for engaging and disengaging rotatable parts therein. Examples include the transmissions disclosed in JP 05-026065 (Transmission Control Device For Motorcycle); JP 2003-148614 (Transmission Device For Motorcycle); JP 2001-208196 (Motor-Driven Transmission For Motorcycle); JP 2003-301859 (Dog Clutch For Motorcycle Transmission), GB 2 081 822 A (Positive Clutch); WO 99/66229 A3 (Six Speed Overdrive Motorcycle Transmission); U.S. Pat. No. 4,019,586 (Shift Dog For Transmission); and U.S. Pat. No. 7,059,210 (Six Speed Motorcycle Transmission). These disclosures are incorporated by reference herein in their entirety.

As illustrated by the aforementioned disclosures, one area of concern in the transmission field involves the engagement and disengagement of gears during a shift from one gear to the next (or between neutral and a first gear). Some transmissions may utilize a shift collar with engagement dogs to engage and disengage a gear. Other transmissions may utilize a shift collar with splines to engage and disengage a gear. Both configurations have advantages and disadvantages related to durability, ease of shifting, likelihood of missing shifts, etc. that have caused developers to seek transmission improvements over the past century. Despite many advances in the transmission art, a need exists for further improvements to address limitations with existing designs.

### BRIEF DESCRIPTION OF THE DRAWINGS

FIG. 1 is a partial side view of a motorcycle including an engine and a transmission according to an embodiment of the present invention.

FIG. 2 is a perspective view of a shift collar engaging a helical transmission gear and a shift sleeve according to an embodiment of the present invention.

FIG. 3A is a top view of the embodiment shown in FIG. 2.

FIG. 3B is a left side view of the embodiment shown in FIG. 2.

FIG. 3C is a bottom view of the embodiment shown in FIG. 2.

FIG. 3D is a right side view of the embodiment shown in FIG. 2.

FIG. 3E is a front view of the embodiment shown in FIG. 2.

FIG. 3F is a sectional view along line A-A of FIG. 3E.

FIG. 4 is an exploded perspective view of the embodiment shown in FIG. 2.

FIG. 5 is a perspective view of a mainshaft assembly and a countershaft assembly of a transmission according to an embodiment of the present invention.

FIG. 6A is a top view of the embodiment shown in FIG. 5.

FIG. 6B is a left side view of the embodiment shown in FIG. 5.

FIG. 6C is a front view of the embodiment shown in FIG. 5.

FIG. 6D is a sectional view along line A-A of FIG. 6C.

FIG. 7 is a flowchart of a method of shifting gears according to an embodiment of the present invention.

### DETAILED DESCRIPTION OF THE EXEMPLARY EMBODIMENTS

As illustrated in the discussion below, various embodiments of the present invention are directed at a shift collar for use in a motorcycle transmission. It should be appreciated, however, that one or more of these embodiments may also be used in other applications, such as automotive transmissions, all terrain vehicle (ATV) transmissions, personal watercraft and boat transmissions, snowmobile transmissions, commercial equipment transmissions, lawn and garden equipment transmissions, etc. Thus, the disclosed embodiments should not be construed as being limited solely to motorcycle transmission applications.

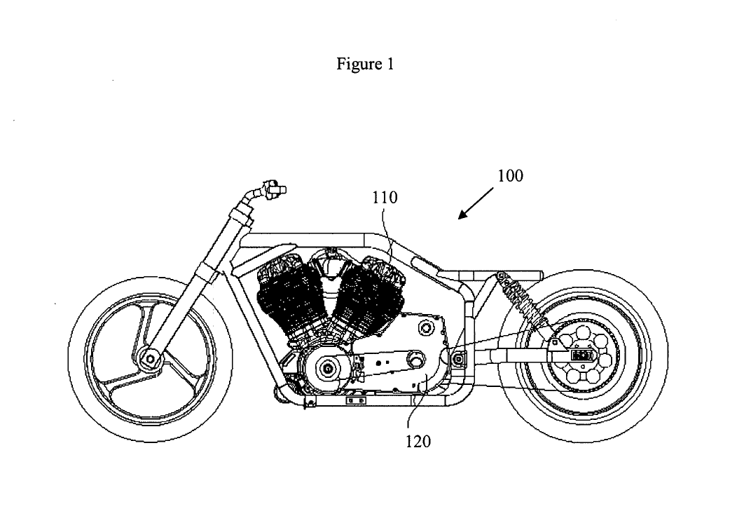

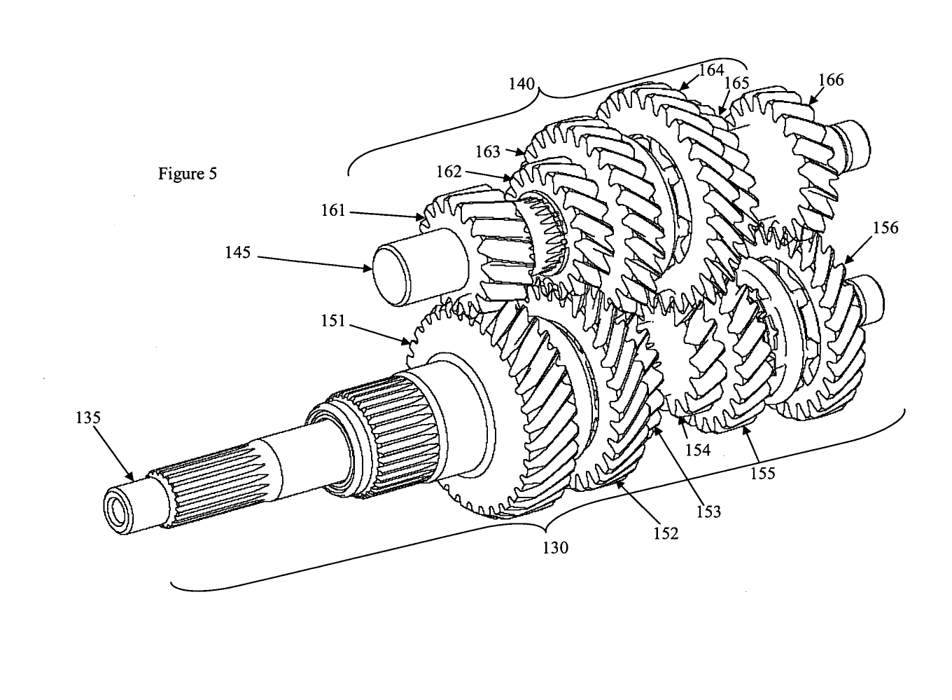

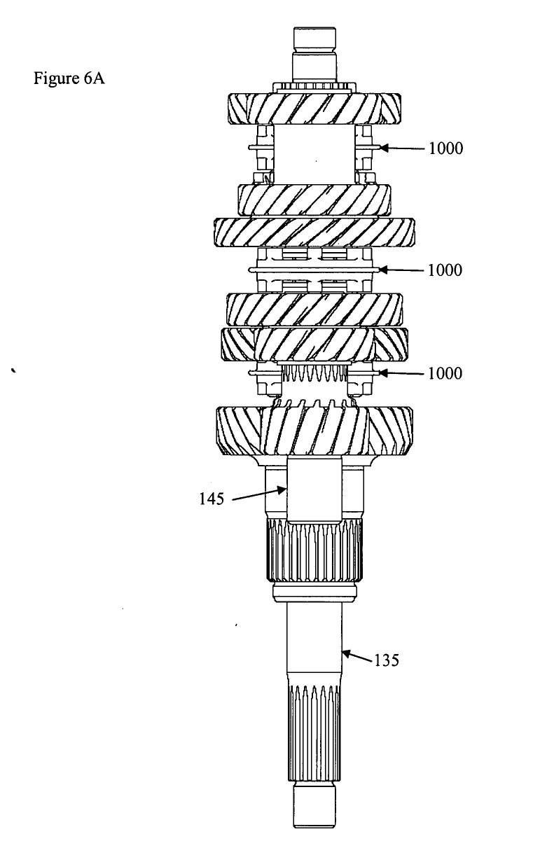

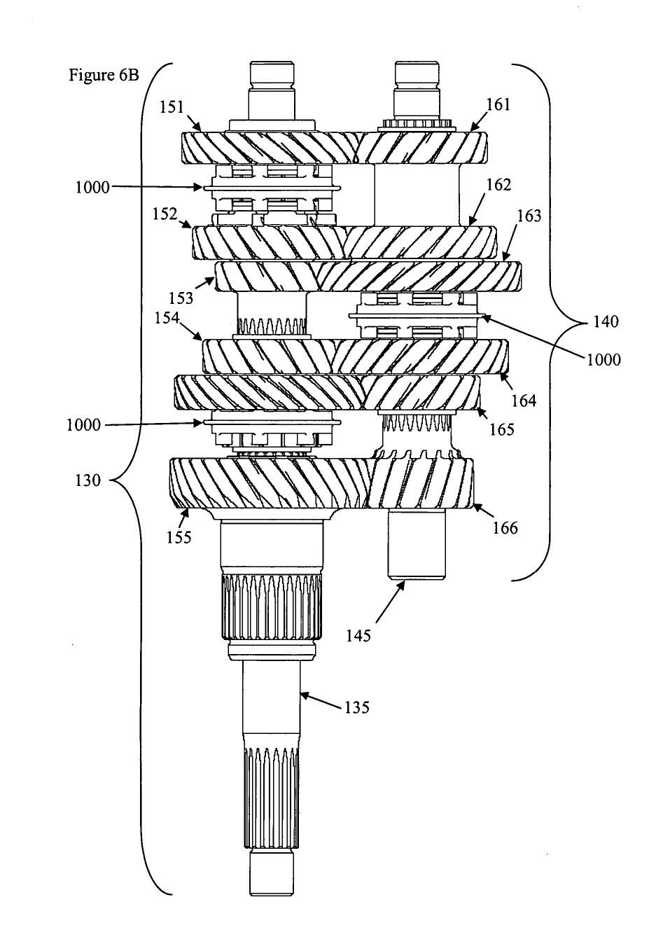

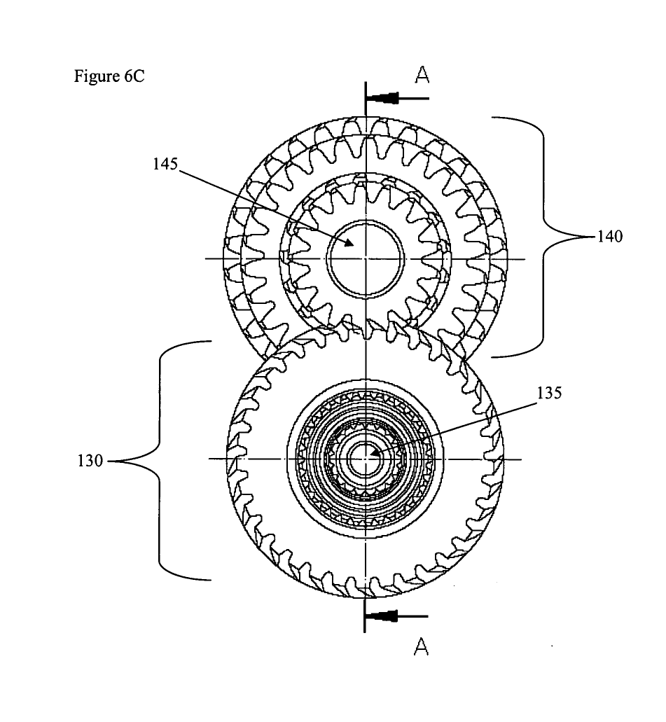

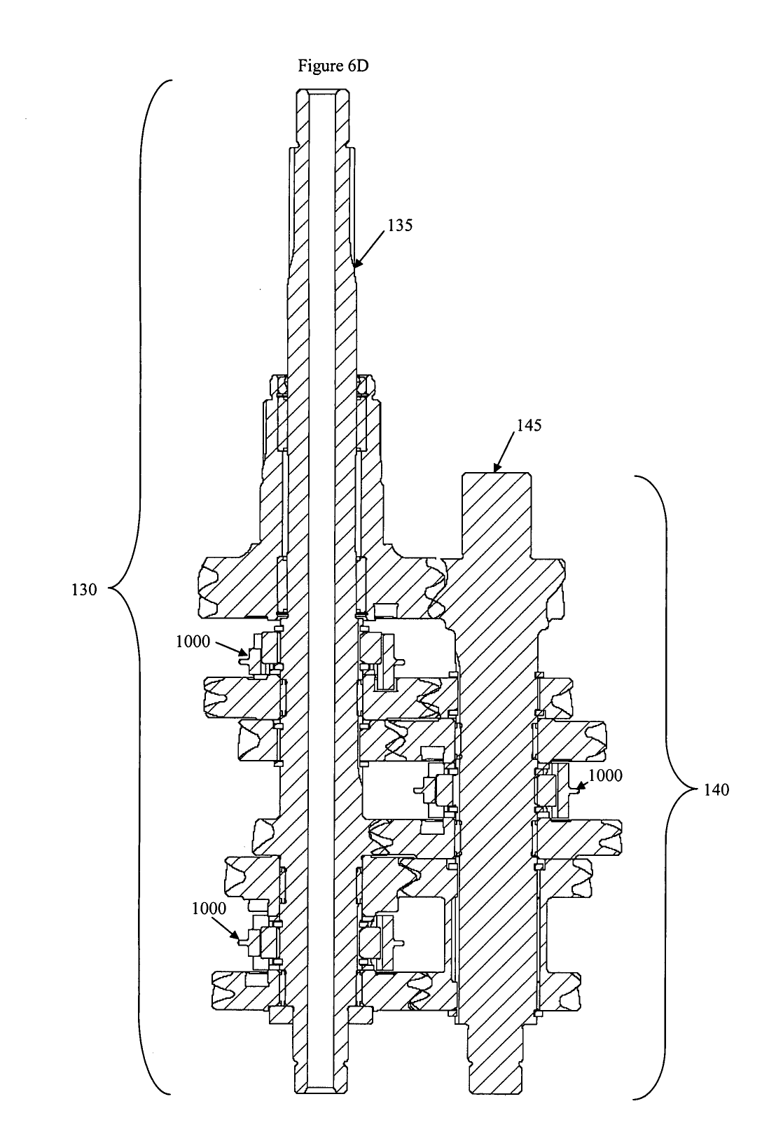

Turning first to FIG. 1, a motorcycle 100 according to an embodiment of the present invention is shown including an engine 110 (e.g., a V-twin type motorcycle engine) and a transmission 120. Power is transmitted from the engine 110 to a rear wheel of the motorcycle 100 via the transmission 120. Specifically, power is first transmitted from the engine 110 to a mainshaft assembly 130 (FIG. 5) of the transmission 120 using a belt or chain drive system. Power is then transferred from the mainshaft assembly 130 to a rear wheel of the transmission through a combination of one or more selectable gears. In a six-speed transmission, for example, power is transferred through a combination of one or more of six gear sets on mainshaft assembly 130 and countershaft assembly 140 (see FIGS. 5-6). Each gear set comprises a main gear 151-156 positioned on the mainshaft 135 and a corresponding counter gear 161-166 positioned on a countershaft 145. Preferably, the main gears 151-156 and counter gears 161-166 are helical gears though other gear profiles may also be used. Several embodiments of the present invention are directed at the manner in which these gears 151-156, 161-166 (and gear sets) are selectably engaged and disengaged so as to transmit power through the transmission 120.

According to one embodiment of the present invention, three identical shift collar assemblies 1000 are provided, wherein each shift collar assembly 1000 selectably engages and disengages one or two of three transmission gear sets. As shown in FIGS. 5-6, each shift collar assembly 1000 is movably positioned between adjacent transmission gears (151/152 and 163/164 and 155/156) such that opposing gear engagement surfaces on a given shift collar assembly 1000 face a corresponding surface on a transmission gear. Other configurations are also contemplated, such as configurations having an individual shift collar assembly 1000 for each transmission gear.

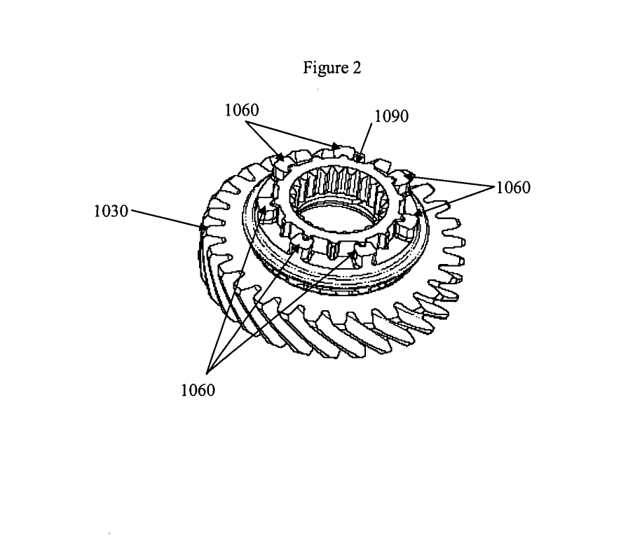

Turning to FIGS. 2-4, each shift collar assembly 1000 preferably includes the two noted gear engagement surfaces (i.e., a first gear engagement surface 1020 for engaging a first transmission gear 1030 and a second gear engagement surface 1040 for engaging a second transmission gear (not shown in FIGS. 2-4)), a shift sleeve engagement surface 1080 extending along an inner diameter of the shift collar assembly 1000, and an outer surface extending along an outer diameter of the shift collar assembly 1000. As described below, the gear engagement surfaces 1020, 1040 may be substantially planar with a plurality of engagement dogs 1060 projecting therefrom. Further, the shift sleeve engagement surface 1080 may be substantially cylindrical with a plurality of grooves 2000 formed therein—the surface 1080 may, of course, be discontinuous in whole or in part. Other configurations are also contemplated, such as a shift collar assembly 1000 with only one gear engagement surface.

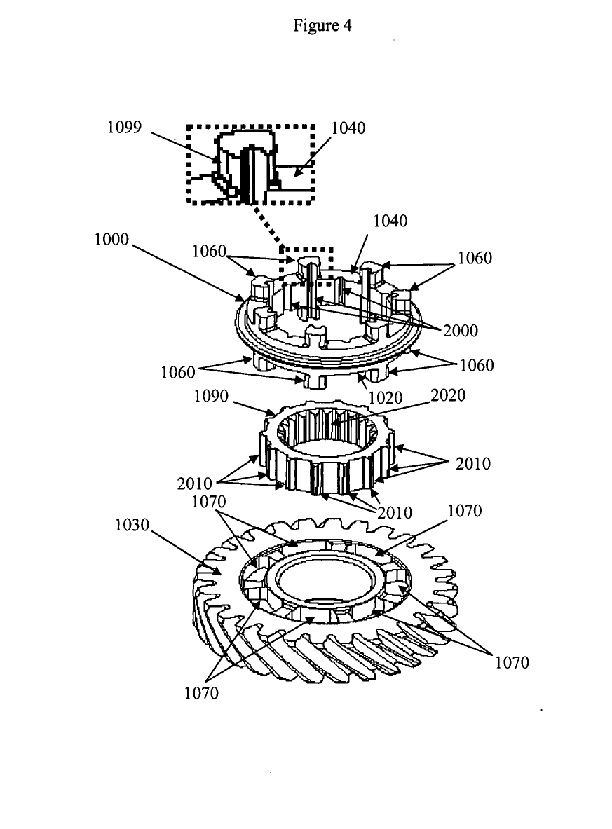

As shown best in FIG. 4, each of the gear engagement surfaces 1020, 1040 may include a substantially symmetric arrangement of engagement dogs 1060 projecting therefrom. Preferably, at least seven engagement dogs 1060 project from each of the gear engagement surfaces 1020, 1040. Most preferably, seven engagement dogs 1060 project from each of the gear engagement surfaces 1020, 1040. The engagement dogs 1060 are arranged on the gear engagement surfaces 1020, 1040 such that when the shift collar assembly 1000 is moved to engage a transmission gear 1030, the engagement dogs 1060 each engage one of a corresponding number of engagement pockets 1070 formed in the engaged transmission gear 1030. To illustrate, when the shift collar assembly 1000 is moved to engage the first transmission gear 1030, each of the engagement dogs 1060 projecting from the first gear engagement surface 1020 engage a corresponding engagement pocket 1070 formed on the first transmission gear 1030. Similarly, when the shift collar assembly 1000 is moved to engage the second transmission gear (not shown in FIGS. 2-4), each of the engagement dogs 1060 projecting from the second gear engagement surface 1040 engage a corresponding engagement pocket 1070 formed on the second transmission gear. Thus, the engagement dogs 1060 and engagement pockets 1070 described above are arranged on the shift collar assembly 1000 and transmission gear 1030 respectively in such a manner as to allow for smooth shifting between gears.

While it is contemplated to arrange the engagement dogs 1060 and engagement pockets 1070 in a variety of configurations, the engagement dogs 1060 are preferably arranged on the gear engagement surfaces 1020, 1040 in a substantially circular pattern concentric with a central axis of the shift collar 1000. More preferably, the engagement dogs 1060 are arranged substantially equiangularly about the central axis of the shift collar 1000. Other, configurations (e.g., those without equiangular spacing of the engagement dogs 1060) are also contemplated. Because the engagement dogs 1060 are to be smoothly and securely received in a corresponding engagement pocket 1070, the engagement pockets 1070 are arranged on the transmission gears 1030 in the same manner as the engagement dogs 1060 are arranged on the gear engagement surface 1020, 1040. This configuration—equiangularly spaced engagement dogs 1060 and a mirror arrangement of engagement pockets 1070—improves the manufacturability of the shift collar 1000 and the balance of the shift collar 1000 as it rotates in a transmission 120 (both in engaged and disengaged positions).

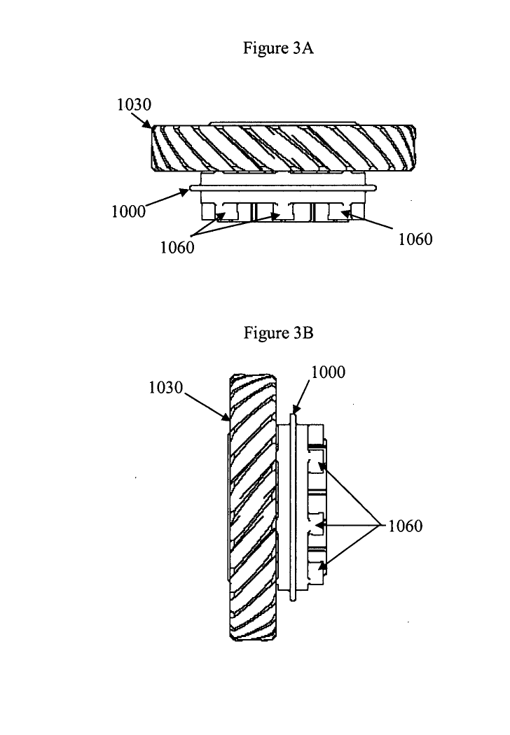

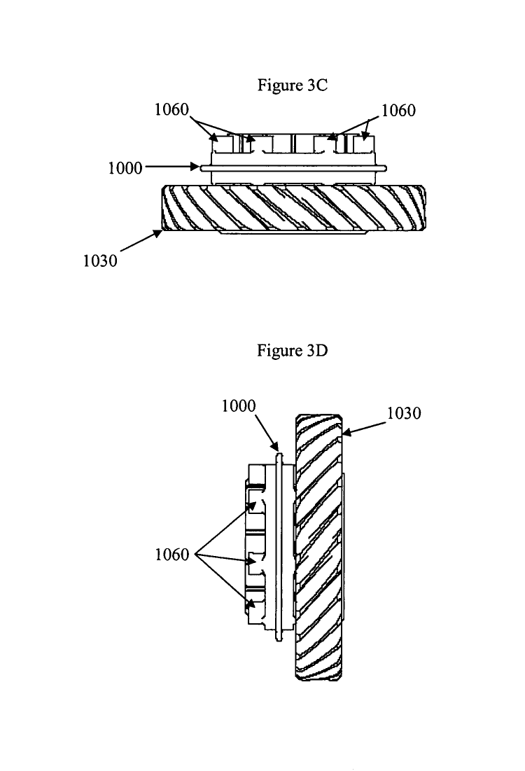

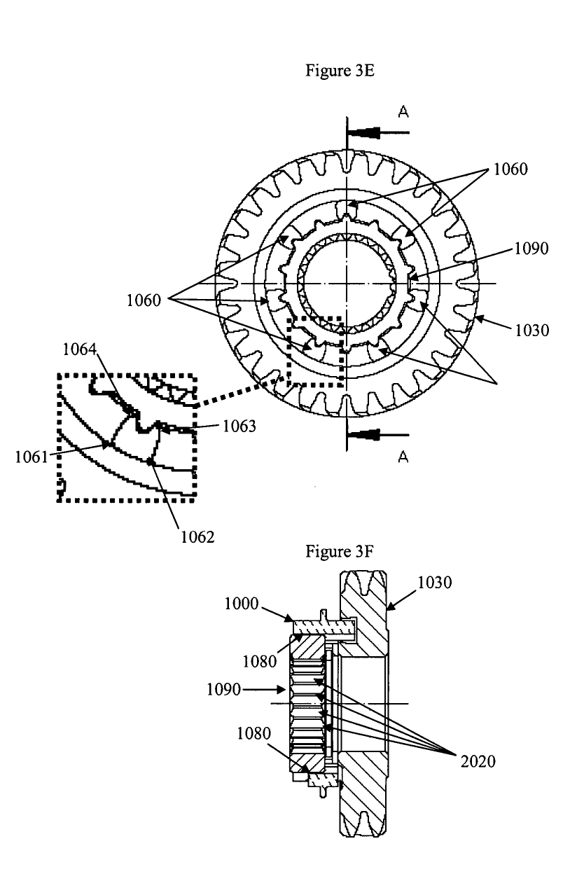

According to another embodiment of the present invention, the engagement dogs 1060 share a common profile as illustrated best in FIGS. 3E and 4. The common profile preferably includes a top surface substantially parallel to the gear engagement surfaces 1020, 1040, an inner surface facing the shift sleeve engagement surface 1080, an outer surface opposing the inner surface, and two side surfaces 1099 extending between the inner surface and the outer surface. The edges of the inner, outer and side surfaces of a given engagement dog 1060 are defined in part by four edges 1061-1064. While the edges 1061-1064 may be sharp edges, some radiusing of one or more of edges 1061-1064 may be advantageous to prevent or reduce stress risers and to promote the movement and engagement of the shift collar 1000. In addition, the edges of the engagement dogs parallel to and intersecting the gear engagement surfaces 1020, 1040 also may be radiused in a like manner. Preferably, all of the edges 1061-1064 (and/or edges parallel to and intersecting the gear engagement surfaces 1020, 1040) are radiused in a range of about 0.025″ to about 0.060″. Most preferably the edges have a radius of about thirty thousandths of an inch.

Further, it should be appreciated that the side surfaces 1099 may be angled with respect to the planar engagement surface 1020, 1040 from which the engagement dogs 1060 project. In other words, the engagement dogs 1060 preferably have a “fatter” cross section on the top surface than at their intersection with the engagement surface 1020, 1040, with side surfaces 1099 that are angled outwardly. The acute angle between a plane perpendicular to the planar engagement surface 1020, 1040 and the plane in which an angled side surface 1099 lies is known in the art as “back angle.” Providing some degree of back angle promotes engagement between the engagement dogs 1060 and the engagement pockets 1070, particularly in configurations where the engagement pockets 1070 are angled outwardly to a degree that closely matches the back angle of the engagement dogs 1060. Specifically, when back angle is provided, the angled side surface 1099 of the engagement dogs 1060 “draws” or “pulls” the engagement dogs 1060 into engagement with the engagement pockets 1070.

According to one embodiment of the present invention, the engagement dogs 1060 (and/or engagement pockets 1070) include a back angle in a range of about 3° to about 5°. More preferably, the engagement dogs 1060 (and/or engagement pockets 1070) include a back angle of about 4°. Other configurations are also contemplated.

In order to reduce the frequency of missed shifts, the engagement dogs 1060 may further be designed to have a relatively small width relative to the width of the engagement pockets 1070. The ratio between engagement pocket width to engagement dog width is commonly referred to as an “aperture ratio” of a transmission. The aperture ratio should be greater than 1:1 because some backlash (defined below) is required for proper operation of the transmission 120. Similarly, problems exist if the aperture ratio is too high because the dogs become too narrow and the engagement pockets 1070 and corresponding webbing becomes too thin to support the torque of the transmission 120. Thus, the aperture ratio is preferably in a range of about 1.5:1 to about 7:1. More preferably, the aperture ratio is in a range of about 2.2:1 to about 3.2:1. Most preferably the aperture ratio is about 2.5:1. In other words, the engagement pockets 1070 are preferably 2.5 times wider than the engagement dogs 1060.

Backlash, referenced above, refers to a gap provided between engaging portions of rotating parts which prevents the parts from jamming and allows room for lubrication. To illustrate, an engagement dog 1060 may be designed to have a thickness smaller than an engagement pocket 1070 on a transmission gear 1030 such that a small gap exists when the engagement dog 1060 is received in the engagement pocket 1070—this gap is commonly known as “backlash.” Too much backlash is undesirable because it may degrade a user's “feel” for the transmission 120 and/or cause a lagging or jerking effect when transitioning from acceleration to deceleration and vice versa. Thus, it is preferable to maintain a relatively low backlash, but a balance must be struck between a low backlash and acceptable aperture ratio and back angle characteristics of the transmission 120.

Given the above, according to one embodiment of the present invention, the engagement dogs 1060 and engagement pockets 1070 are designed such that the transmission 120 has a backlash in a range of about 20° to about 30° and a back angle in a range of about 3° to about 5°. More preferably, the engagement dogs 1060 and engagement pockets 1070 are designed such that the transmission 120 has a backlash of about 24.4 and a back angle of about 4°. These design specifications may, of course, take into consideration the preferred aperture ratios previously discussed.

Turning next to FIGS. 2-4, another embodiment of the present invention is directed at the manner in which the shift collar 1000 is coupled to a mainshaft 135 or countershaft 145 of the transmission 120. Specifically, the shift collar 1000 may include a shift sleeve engagement surface 1080 for engaging a shift sleeve 1090. The shift sleeve engagement surface 1080 may extend along an inner diameter of the shift collar 1000, and include a plurality of grooves 2000 formed therein that receive corresponding splines 2010 on shift sleeve 1090. Preferably, the grooves 2000 extend from the first gear engagement surface 1020 through the shift collar 1000 to the second gear engagement surface 1040 as illustrated. Because the splines 2010 of the shift sleeve 1090 engage the grooves 2000 of the shift collar 1000, the shift sleeve 1090 and shift collar 1000 are rotatably coupled (i.e., rotation of one of the shift collar 1000 and shift sleeve 1090 causes a corresponding rotation in the other of the shift collar 1000 and the shift sleeve 1090). In order to ensure a secure engagement between shift sleeve 1090 and shift collar 1000, at least fourteen grooves 2000 and at least fourteen splines 2010 are provided.

According to one embodiment of the present invention, at least one groove 2000 extends through a center of the inner surface of each engagement dog 1060. By providing grooves 2000 in the engagement dogs 1060, the engagement dogs 1060 help support the shift collar 1000 on the corresponding shaft. This allows the number of engagement dogs 1060 to be increased without sacrificing the degree of support for the shift collar 1000.

In addition to outer splines 2010, it should be appreciated that the shift sleeve 1090 may further include a plurality of inner splines 2020. Inner splines 2020 engage corresponding splines on the mainshaft 135 or countershaft 145 of the transmission 120 such that the shift sleeve 1090 and mainshaft are rotatably coupled (i.e., rotation of one of the shift sleeve 1090 and mainshaft/countershaft causes a corresponding rotation in the other of the shift sleeve 1090 and mainshaft/countershaft). In order to ensure a secure engagement between shift sleeve 1090 and mainshaft/countershaft, at least 23 splines 2020 are provided. Other configurations are also contemplated.

If the shift collar 1000 is rotatably coupled to the shift sleeve 1090, it follows that the shift collar 1000 is rotatably coupled to the mainshaft/countershaft via the shift sleeve 1090. The shift collar 1000 is not, however, rigidly attached to the shift sleeve 1090 or to the mainshaft/countershaft via the shift sleeve 1090. Rather, the shift collar 1000 is slidably positioned on the shift sleeve 1090 such that the shift collar 1000 can be laterally moved in a direction parallel to an axis about which the shift sleeve 1090 rotates. As described in greater detail below, lateral movement of the shift collar 1000 causes the shift collar 1000 to selectably engage and disengage the transmission gears 1030, thereby effecting a gear change.

Those of skill in the art will appreciate that many different techniques may be used to cause the shift collar 1000 to move laterally with respect to the axis about which the shift sleeve 1090 rotates, any of which may be used with various embodiments of the present invention. As is described in the U.S. Provisional Patent Application Ser. No. 60/698,108 (filed Jul. 11, 2005), for example, lateral movement of the shift collar 1000 may be provided using one or more shift forks (the '108 application is incorporated by reference herein in its entirety). Specifically, when a shifter weldment is moved, this causes lateral movement of one or more shift forks. The shift forks, in turn, each laterally move a corresponding shift collar 1000 into engagement and/or out of engagement with corresponding transmission gears 1030. This effects a gear change in the transmission 120. Other configurations are also contemplated.

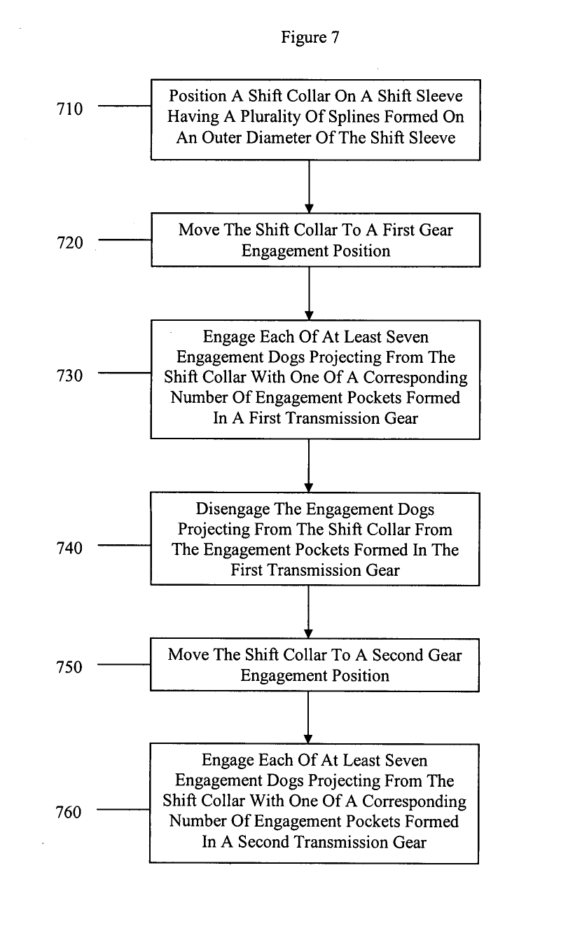

According to another embodiment of the present invention, a method of shifting gears in a motorcycle transmission may be performed using a shift collar assembly such as the shift collar assembly 1000 disclosed in the previously described embodiments. As shown in FIG. 7, the method of the present embodiment comprises a first step 710 of providing a shift collar (e.g., shift collar assembly 1000) on a shift sleeve (e.g., shift sleeve 1090) having a plurality of splines (e.g., splines 2010) formed on an outer diameter of the shift sleeve. Step 710 may be performed with other transmission assembly steps, such as positioning a mainshaft assembly 130 and/or countershaft assembly 140 in a transmission housing, providing shift forks within the transmission housing for laterally moving the shift collars, etc.

Once step 710 has been completed, the transmission is ready for operation. Thereafter, during use of the transmission, when a user seeks to shift gears (e.g., from neutral to first, first to second, second to third, third to fourth, fourth to fifth, fifth to sixth, sixth to fifth, fifth to fourth, fourth to third, third to second, second to first, first to neutral), the user causes the shift collar to be moved to a first gear engagement position in step 720. As an example, a user may operate a shifter weldment which causes lateral movement of one or more shift forks. Lateral movement of the shift forks, in turn, cause lateral movement of one or more shift collar assemblies, thereby causing the shift collar to be moved to the first gear engagement position. According to some embodiments, multiple shift collars may be moved into engagement with corresponding transmission gears as part of step 720 (preferably simultaneously).

As the shift collar is moved into the first gear engagement position in step 720, at least seven engagement dogs (e.g., engagement dogs 1060) projecting from the shift collar engage in step 730 a corresponding number of engagement pockets (e.g., engagement pockets 1070) on a first transmission gear (e.g., gear 1030). The engagement dogs (and/or engagement pockets) may include an angled side surface (e.g., side surface 1099) such that the engagement dogs “pull” or “draw” themselves into proper alignment with the engagement pockets as part of step 730, thereby helping to attain a positive engagement during a partial shift under load and to maintain a positive engagement under load. Once step 730 has been completed, the user has effected a shift into the desired gear and power is transmitted through the transmission using the selected and engaged gear.

When a user desires a shift into a different gear, the user again causes the shift collar to be moved—this time away from the first gear engagement position. As an example, the user may operate the noted shift weldment as previously described. As the shift collar is moved away from the first gear engagement position, the engagement dogs are disengaged from the engagement pockets in the previously selected gear in step 740. Thereafter, a shift collar is moved to a second gear engagement position in step 750—i.e., to engage the gear desired by the user. The shift collar moved in step 750 may be the same shift collar moved in step 720 or may be a different shift collar in the transmission, or the same shift collar may be moved in combination with other shift collars. Step 750 may be performed, for example, using the shift forks previously described.

As the shift collar is moved to the second gear engagement position in step 750, at least seven engagement dogs projecting from the shift collar engage in step 760 a corresponding number of engagement pockets on a second transmission gear. One of skill in the art will appreciate that step 760 is analogous to step 740, albeit with a different transmission gear. If the shift collar moved in step 750 is the same as the shift collar moved in step 720, the engagement dogs referenced in step 760 are preferably on an opposite side of the shift collar as the engagement dogs referenced in step 730. Further, if the shift collars moved in steps 750 and 720 are the same, the movement referenced in step 750 occurs in an opposite direction as the movement referenced in step 720.

Once step 760 has been completed, the user has effected a shift into the desired gear. Thereafter, similar gear shifts may be performed using steps analogous to those previously described. In a six speed transmission, for example, a user may shift between six gear sets and a neutral position—i.e., seven “shifting” operations may be performed. Other configurations are also contemplated.

The above described embodiments may provide numerous advantages over known configurations. To illustrate, deficiencies in previously known transmissions could not be sufficiently addressed by simple design changes because compromises had to be made between the strength of the components therein and the overall performance of the transmission, tight limits on acceptable backlash and back angle had to be maintained, and known manufacturing limitations had to be taken into account. Embodiments of the present invention, by contrast, can be used to fabricate a helical transmission with minimal missed shifts, a relatively high 2.5:1 aperture ratio, an acceptable 24° of backlash, and an acceptable 4° back angle. Such a configuration is relatively easy to manufacture, and offers improved performance over known designs. Other advantages may also be realized by those of skill in the art.

The foregoing description of various embodiments of the present invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated.

EXEMPLARY PARTS LIST

| | |
|---|---|
| counter gear | 161-166 |
| countershaft | 145 |
| countershaft assembly | 140 |
| edges of engagement dog | 1061-1064 |
| engagement dog | 1060 |
| engagement pocket | 1070 |
| engine | 110 |
| first gear engagement surface | 1020 |
| first transmission gear | 1030 |
| grooves | 2000 |
| main gear | 151-156 |
| mainshaft | 135 |
| mainshaft assembly | 130 |
| motorcycle | 100 |
| second gear engagement surface | 1040 |
| shift collar assembly | 1000 |
| shift sleeve | 1090 |
| shift sleeve engagement surface | 1080 |
| side surface | 1099 |
| splines | 2010, 2020 |
| transmission | 120 |

What is claimed is:

1. A shift collar for a motorcycle transmission, the shift collar comprising:
a first gear engagement surface for engaging a first transmission gear;
at least seven engagement dogs projecting from the first gear engagement surface, the engagement dogs being arranged on the first gear engagement surface such that each of the engagement dogs engage one of a corresponding number of engagement pockets in the first transmission gear;
a shift sleeve engagement surface for engaging a shift sleeve; and
a plurality of grooves formed in the shift sleeve engagement surface for engaging corresponding splines on the shift sleeve.

2. The shift collar of claim 1,
wherein the shift sleeve engagement surface extends along an inner diameter of the shift collar, and
wherein the plurality of grooves extend from the first gear engagement surface through the shift collar to a second gear engagement surface.

3. The shift collar of claim 2, wherein the shift collar includes fourteen grooves formed in the shift sleeve engagement surface.

4. The shift collar of claim 1, wherein at least one of the plurality of grooves is formed in an inner surface of each engagement dog for receiving one of the corresponding splines on the shift sleeve.

5. The shift collar of claim 1, further comprising:
a second gear engagement surface for engaging a second transmission gear; and
at least seven engagement dogs projecting from the second gear engagement surface, the engagement dogs being arranged on the second gear engagement surface such that each of the engagement dogs engage one of a corresponding number of engagement pockets in the second transmission gear.

6. The shift collar of claim 5, wherein the engagement dogs projecting from the first gear engagement surface are arranged symmetrically with the engagement dogs projecting from the second gear engagement surface.

7. The shift collar of claim 1, wherein the first gear engagement surface is substantially planar.

8. The shift collar of claim 1, wherein the shift collar includes seven engagement dogs.

9. The shift collar of claim 1, wherein the engagement dogs are arranged on the first gear engagement surface in a substantially circular pattern concentric with a central axis of the shift collar.

10. The shift collar of claim 9, wherein the engagement dogs are disposed substantially equiangularly about the central axis of the shift collar.

11. The shift collar of claim 1, wherein the engagement dogs share a common profile.

12. The shift collar of claim 1,
wherein each engagement dog includes an outer surface parallel to the first gear engagement surface, the outer surface having an inner edge corresponding to an outer diameter of the shift sleeve, an outer edge opposite the inner edge, and two side edges extending between the inner edge and the outer edge, and
wherein the two side edges are radiused.

13. The shift collar of claim 12, wherein each of the two side edges has a radius in a range of about 0.025″ to about 0.060″.

14. The shift collar of claim 13, wherein each of the two side edges has a radius of about 0.03″.

15. The shift collar of claim 1,
wherein each engagement dog includes a plurality of edges parallel to and intersecting the first gear engagement surface, and
wherein the plurality of edges are radiused.

16. The shift collar of claim 15, wherein the plurality of edges include a radius in a range of about 0.025″ to about 0.060″.

17. The shift collar of claim 16, wherein the plurality of edges include a radius of about 0.03″.

18. The shift collar of claim 1, wherein an aperture ratio of the motorcycle transmission is in a range of about 2.2:1 to about 3.2:1.

19. The shift collar of claim 18, wherein the aperture ratio is about 2.5:1.

20. The shift collar of claim 1, wherein a backlash of the motorcycle transmission is in a range of about 20° to about 30°.

21. The shift collar of claim 20, wherein the backlash is about 24.4°.

22. The shift collar of claim 20, wherein an aperture ratio of the motorcycle transmission is in a range of about 2.2:1 about 3.2:1.

23. The shift collar of claim 22, wherein a back angle of the motorcycle transmission is in a range of about 3° to about 5°.

24. The shift collar of claim 20, wherein a back angle of the motorcycle transmission is in a range of about 3° to about 5°.

25. The shift collar of claim 1, wherein a back angle of the motorcycle transmission is in a range of about 3° to about 5°.

26. The shift collar of claim 25, wherein the back angle is about 4°.

27. A six-speed motorcycle transmission including the shift collar of claim 1.

28. A motorcycle including the six-speed motorcycle transmission of claim 27.

29. The shift collar of claim 1, wherein the splines traverse substantially through the middle of the engagement dogs.

30. The shift collar of claim 1, wherein the engagement dogs are timed to the shift sleeve engagement surface.

31. A method of shifting gears in a motorcycle transmission comprising:
positioning a shift collar on a shift sleeve having a plurality of splines formed on an outer diameter of the shift sleeve;
moving the shift collar to a first gear engagement position; and
engaging each of at least seven engagement dogs projecting from the shift collar with one of a corresponding number of engagement pockets formed in a first transmission gear.

32. The method of claim 31, further comprising:
drawing the shift collar toward the first transmission gear to maintain a positive engagement under load.

33. The method of claim 31, further comprising:
disengaging the engagement dogs projecting from the shift collar from the engagement pockets formed in the first transmission gear;
moving the shift collar to a second gear engagement position; and
engaging each of at least seven engagement dogs projecting from the shift collar with one of a corresponding number of engagement pockets formed in a second transmission gear.

34. The method of claim 33,
wherein moving the shift collar to the first gear engagement position comprises lateral movement in a first direction parallel to an axis about which the shift sleeve rotates,
wherein moving the shift collar to the second gear engagement position comprises lateral movement in a second direction parallel to the axis about which the shift sleeve rotates, and
wherein the first direction is opposite the second direction.

35. The method of claim 31, further comprising:
drawing the shift collar toward an adjacent gear to maintain positive engagement under load.

36. The method of claim 31, further comprising:
drawing the shift collar toward an adjacent gear to attain positive engagement during a partial shift under load.

37. The method of claim 31, wherein engaging each of at least seven engagement dogs comprises engaging the shift collar with the shift sleeve substantially through the middle of the engagement dogs.

38. A transmission comprising:
a mainshaft assembly including a plurality of main gears mounted on a mainshaft;
a countershaft assembly including a plurality of counter gears mounted on a countershaft, each of the counter gears engaging a corresponding one of the plurality of main gears;
a plurality of shift collar assemblies for each selectively engaging and disengaging at least one of said gears; and
a plurality of shift sleeves, each of the shift sleeves movably coupling one of the plurality of shift collar assemblies to one of the mainshaft assembly and the countershaft assembly,
wherein an aperture ratio of the transmission is in a range of about 2.2:1 to about 3.2:1,
wherein a backlash of the transmission is in a range of about 20° to about 30°, and
wherein a back angle of the transmission is in a range of about 3° to about 4°.

39. The transmission of claim 38, wherein the aperture ratio is about 2.5:1, the backlash is about 24.4°, and the back angle is about 4°.

40. The transmission of claim 38, wherein the main gears and the counter gears are helical gears.
